(19) United States
(12) Patent Application Publication
(10) Pub. No.: US 2023/0051714 A1
(43) Pub. Date: Feb. 16, 2023

(54) METHOD AND SYSTEM FOR PRE-OPTIMIZING AGRICULTURAL WORK PROCESS FOR AGRICULTURAL COMBINATIONS

(71) Applicant: CLAAS Tractor SAS, VeIizy-Villacoublay Cedex (FR)

(72) Inventors: Christian Birkmann, Versmold (DE); Jan Carsten Wieckhorst, Uelzen Ortsteil Hanstedt (DE); Jona Pieper, Nordkirchen (DE); Christian Schaub, Paderborn (DE); Christian Ehlert, Bielefeld (DE); Lennart Meyer, Aachen (DE)

(73) Assignee: CLAAS Tractor SAS, VeIizy-Villacoublay Cedex (FR)

(21) Appl. No.: 17/880,906

(22) Filed: Aug. 4, 2022

(30) Foreign Application Priority Data
Aug. 10, 2021 (DE) 10 2021 120 762.2

(51) Int. Cl. A01B 63/111; A01B 79/00

(52) U.S. Cl. CPC A01B 63/1112; A01B 79/00

(57) ABSTRACT

A system and method for controlling, such as pre-optimizing, agricultural work processes for agricultural combinations is disclosed. Agricultural combinations include an agricultural production machine and different agricultural attachments. A sensor assembly determines an absolute working height of the agricultural attachments using a sensor measuring data regarding the absolute working height. The agricultural combination includes a combination control assembly that controls and/or regulates machine parameters of the particular agricultural combination based on an optimization data set and the measured data obtained during the working process. An optimization control assembly determines the optimization data set from competing optimization goals, optimization data both apart from and relating to the combination. The sensor assembly determines the absolute working height of the different agricultural attachments using the same sensor, and the optimization data set suggests the optimized working height of the agricultural attachment and/or suggestions for optimized settings of other machine parameters of the agricultural combination.

### CROSS REFERENCE TO RELATED APPLICATION

This application claims priority under 35 U.S.C. § 119 to German Patent Application No. DE 10 2021 120 762.2 filed Aug. 10, 2021, the entire disclosure of which is hereby incorporated by reference herein. This application is further related to: US Utility application Ser. No. ______ (attorney docket no. 15191-22008A (P05464/8)); US Utility application Ser. No. ______ (attorney docket no. 15191-22009A (P05465/8)); US Utility application Ser. No. ______ (attorney docket no. 15191-22010A (P05466/8)); US Utility application Ser. No. ______ (attorney docket no. 15191-22012A (P05470/8)); US Utility application Ser. No. ______ (attorney docket no. 15191-22013A (P05499/8)), each of which are incorporated by reference herein in their entirety.

### TECHNICAL FIELD

The present invention relates to a method and system for controlling, such as pre-optimizing, agricultural work processes for agricultural combinations.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural production machines such as combines, forage harvesters, and tractors can be combined with various attachments. These attachments may be attached via an equipment interface to the agricultural production machine. In one or some embodiments, agricultural combinations comprise an agricultural production machine and an agricultural attachment in combination. In one or some embodiments, the agricultural attachment attached to the agricultural production machine may be an independent vehicle. In one or some embodiments, the agricultural attachment may be pulled by the agricultural production machine.

Such attachments may perform an agricultural job, such as fieldwork. The fieldwork may, for example, be a sowing or fertilization processes, the application of pesticides, working the soil like plowing, or harvesting processes like mowing. Common to these types of fieldwork is that the agricultural attachments are generally adjusted to a specific working height. The working height may, for example, also assume a negative value, such as in case of plowing, and may therefore be a working depth. The success, and to an extent the energy consumption of the fieldwork, frequently depends largely on the working height. At the same time, however, it depends on various machine parameters of the agricultural attachment of the agricultural production machine.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates an agricultural fleet with the sensor assembly while the disclosed method is being performed, and

FIGS. 2A-D illustrate different agricultural attachments with which the disclosed method may be performed.

### DETAILED DESCRIPTION

As discussed in the background, the energy consumption of the fieldwork may depend largely on the working height. However, it may be very difficult to find settings for a fuel, performance, cost or optimum work quality setting for agricultural production machines. These may depend on the features of the particular agricultural production machine and the particular agricultural attachment, as well as the features of the field and the overall context of an agricultural business.

A cost-optimized setting of the agricultural combination may not, for example, be made solely on site during a work process when the cost factors such as labor costs, machine costs, fuel costs, etc. that apply to the business are unknown.

DE 10 2017 116 593 A1 and DE 10 2018 111 076 A1 (corresponding US Published Application No. 2019/0343044 A1, incorporated by reference herein in its entirety) may assist the user when setting machine parameters of the agricultural combination. Systems for pre-estimating optimized settings may be used as well.

In principle, optimization data apart from the combination such as the cost of machines, personnel, raw materials, etc., soil types, crop sequences of a field, general planning, etc. may be taken into account in order to determine an optimization data set that may be used by the agricultural combination to set machine parameters.

However, it may be challenging to determine optimized settings for machine parameters. The working height is a particularly relevant machine parameter that is complex to determine and is therefore costly in terms of the necessary hardware and software.

Thus, in one or some embodiments, a method and system are disclosed to address designing and developing a methodology to achieve further optimization with respect to the aforementioned challenge.

In one or some embodiments, a fundamental consideration may be that a sensor may be used to determine an absolute working height of a plurality of different agricultural attachments, and that an optimization data set may be determined such that optimization targets, optimization data apart from the combination and optimization data of the combination are combined in order, for example, to propose an optimized working height on the basis of user specifications, measured values or the like, or to optimize other machine parameters with respect to the optimization targets on the basis of a set working height.

Reusing the sensor makes it possible to economically determine the absolute working height. By combining this important machine parameter with other optimization data, improved overall optimization of the working process may be achieved. The option of optimizing the working heights of different agricultural attachments may be of particular interest.

Thus, in one or some embodiments, the sensor assembly is configured to determine the absolute working height of a plurality of different agricultural attachments using the same sensor, and that the optimization data set has a suggestion for a working height of the agricultural attachment optimized with regard to the optimization goals, and/or suggestions (e.g., parameters and/or guidelines) for settings of other machine parameters of the agricultural combination that are dependent on a set working height and optimized with regard to the optimization goals.

Thus, in one or some embodiments, a method and system are disclosed for controlling (such as pre-optimizing) agricultural work processes for agricultural combinations. The agricultural combinations may have an agricultural production machine and different agricultural attachments. Further, a sensor assembly is included and configured to determine a working height, such as an absolute working height, of the different agricultural attachments. The agricultural combination further may include a combination control assembly, with the sensor assembly having a sensor for determining or generating measured data relating to the absolute working height, a sensor holder and a sensor control assembly. When the sensor is in the state mounted at a mounting position (e.g., the sensor is within or connected to the sensor holder), the sensor records measured data relating to an absolute working height of the particular attachment (e.g., the particular attachment to which the sensor is temporarily housed) and transmits at least a part of the measured data to the combination control assembly. In turn, the combination control assembly performs one or both of controlling or regulating machine parameters of the particular agricultural combination (e.g., the agricultural production machine and the particular attachment) based on an optimization data set and the measurement data during the working process. Further, the performance control assembly (such as the optimization control assembly) may execute an optimization routine to determine the performance data set (e.g., the optimization data set) from competing performance goals (e.g., optimization goals), performance data apart from the agricultural combination (e.g., optimization data apart from the combination), and performance data apart relating to agricultural combination (e.g., optimization data relating to the combination). In one or some embodiments, this performance data set may be generated before performing the work process. The performance data set may be made available to the combination control assembly (11). The performance data set (e.g., the optimization data set) may include suggestions for settings of machine parameters of the agricultural combination with are selected with respect to performance goals depending on other machine parameters of the agricultural combination (e.g., optimized with respect to the optimization goals depending on other machine parameters of the agricultural combination) and/or measured data of the agricultural combination. Further, the sensor assembly may be configured to determine the absolute working height of a plurality of different agricultural attachments using the same sensor. The performance data set (e.g., the optimization data set) may further have a suggestion for a working height of the agricultural attachment selected with regard to the performance goals (e.g., optimized with regard to the optimization goals), and/or suggestions for settings of other machine parameters of the agricultural combination that are dependent on a set working height and selected with regard to the performance goals (e.g., optimized with regard to the optimization goals).

In one or some embodiments, the sensor may be reversibly mounted on the agricultural attachments and may be used to determine the working height of the plurality of attachments. Such a modular sensor system may enable economic measurement of the working height of different agricultural attachments. If the sensor holder may be mounted on the agricultural attachment separately from the sensor and may be designed so that the sensor holder remains on the agricultural attachment (e.g., the sensor holder is mounted to remain fixed to the agricultural attachment longer than the sensor is), mounting the sensor is also quick and easy. It is therefore possible to measure working heights of several agricultural attachments with only one or a few sensors. Accordingly, fieldwork may be improved, such as better optimized, in an economical manner.

In one or some embodiments, the sensor may be designed as a distance sensor. Various distance sensors are contemplated. For example, the distance sensor may function on the basis of electromagnetic waves, or acoustic waves, or mechanical sensing. Moreover, in one or some embodiments, the distance sensor comprises a radar sensor, or a lidar sensor, or an optical sensor, or an ultrasonic sensor. Or, the sensor may comprise a force sensor or position sensor, on a component touching the ground, in particular a sensing bracket, a grinding skid or a support roller. These types of sensors have especially proven themselves in the agricultural sector. In particular, there is a good balance between robustness and cost.

In one or some embodiments, the performance data set (e.g., the optimization data set) may have characteristic diagrams that depict the dependencies of the settings of machine parameters of the agricultural combination on other machine parameters of the agricultural combination and/or measured data. Such characteristic diagrams may have the advantage that they are optimized for a specific operating point or operating range, and changes of machine parameters may be depicted within this operating range with little computing effort. This, in one or some embodiments, the combination control assembly may control the agricultural combination within an operating range of the characteristic diagrams based on the characteristic diagrams. Accordingly, changes of machine parameters may be understood as movements on the characteristic diagrams that do not generally necessitate any change of the characteristic diagrams. Only when basic assumptions or major changes result are the characteristic diagrams adapted in this case in order to react thereto (e.g., the characteristic diagrams are adapted or modified when the working or operating range of the characteristic diagrams is left or the agricultural combination is operated outside, such as markedly outside, of the working or operating range). Thus, in one or some embodiments, as long as the characteristic diagrams themselves do not change, one may therefore talk of controlling. Further, in one or some embodiments, changing the characteristic diagrams may correspond to a type of regulation.

In one or some embodiments, the performance data set (e.g., the optimization data set) may be dependent on the mounting position (e.g., may be mounting position specific). This may take into account the fact that not every random working height of an agricultural attachment may always be exchangeably used. Depending on the mounting position, the working height may be considered differently. Thus, the performance data set (e.g., the optimization data set) may have at least one mounting-position-dependent characteristic diagram (e.g., the mounting-position-dependent characteristic diagram depicts the settings of machine parameters of the agricultural combination depending on the working height at the specific mounting position). The mounting position itself may, as explained below, also be the subject of optimization.

In one or some embodiments, settings may depend on the set working height that may be determined from the performance data set (e.g., the optimization data set). In particular, the performance data set (e.g., the optimization data set) comprises suggestions of settings for motor regulation depending on the set working height, and/or a driving regulation, and/or a transmission regulation, and or a fan regulation, and/or for regulation of the equipment interface, such as a traction regulation, and/or a slip regulation, and/or a position regulations, and/or a mixing regulations of the traction and position regulation, and/or for contact pressure regulation, and/or a re-hardening regulation, and/or a seeding rate regulation of the agricultural attachment.

In one or some embodiments, in addition to the specific combination optimization, it is also contemplated to select (such as to optimize the selection of) the agricultural production machine and/or the agricultural attachment, or predefined combinations, and/or configurations of the sensor assembly. Accordingly for example, different agricultural attachments may be distributed to different work processes, the available sensors may also be distributed to maximize their use, and all the possibilities of the optimization data set may be taken into account for the combinations. At the same time, the made suggestions may also be taken into account in the optimization data sets. Thus, in one or some embodiments, the performance control assembly (e.g., optimization control assembly) determines suggestions in the performance routing (e.g., the optimization routine) for a performance choice (e.g., an optimized choice) for a variety of things, such as the choice of one or more agricultural production machines, and/or agricultural attachments, and/or agricultural combinations for the work process. Alternatively, or in addition, the performance control assembly (e.g., optimization control assembly) determines suggestions in the performance routing (e.g., the optimization routine) for a performance selection (e.g., an optimized selection) of one or more sensors, and/or sensor types, and/or mounting positions, and/or a number of sensors in the sensor assembly.

In one or some embodiments, there may be at least several competing performance goals (e.g., optimization goals). As such, there may be weightings for these performance goals (e.g., optimization goals) that are already taken into account in the performance routine (e.g., the optimization routine) for selecting the performance data set (e.g., for optimizing the optimization data set). It is also contemplated to change the weightings of at least some target specifications while performing the work process. For example, a change in the weather may cause the speed to be prioritized over cost. This change may be spontaneously warranted on the field. Thus, the performance control assembly (e.g., the optimization control assembly) may determine the performance data set (e.g., the optimization data set) in the performance routine (e.g., the optimization routine) depending on weightings of target specifications. In one or some embodiments, the weighting of the target specifications is incorporated in the characteristic diagrams, and may change to the weighting of at least some target specifications cannot force a change to the characteristic diagrams while the work process is being performed.

In one or some embodiments, an optimized working height is determined during the work process based on new or changed weightings of the target specifications. This may allow the working height to be dynamically optimized as a particularly relevant machine parameter. As such, in one or some embodiments, the user may specify dialog-based weightings of the target specifications for controlling and/or regulating the agricultural combination during the work process. The performance data set (e.g., the optimization data set) may comprise an optimized working height depending on the target specifications. Further, the combination control assembly may suggest and/or regulate (e.g., automatically send commands in order automatically regulate) an optimized working height based on the optimization data set and the target specifications. Further, the combination control assembly may suggest and regulate (e.g., automatically regulate) optimized different machine parameters based on the optimization data set, and the target specifications, and the optimized working height.

In one or some embodiments, it is contemplated to also determine suggestions for defaults of the agricultural work machine and/or the agricultural attachment and taking them into account in the performance data set (e.g., the optimization data set). These defaults may comprise settings that cannot be readily changed during the work process. Examples are an axle ballast or tire pressure. Thus, in one or some embodiments, the optimization control assembly may determine suggestions for defaults of the agricultural production machine and/or the agricultural attachment (3) in the optimization routine. Moreover, the optimization data set, such as the characteristic diagrams in the optimization data set, may be dependent on the suggestions.

In one or some embodiments, other performance data (e.g., optimization data) apart from the combination may be generated and used. These other performance data may make it possible to effectively take into account influential factors in the optimization data set that cannot be readily determined or taken into account on the field, or that do not generally relate directly to the combination, such as for example the weather. In this regard, in one or some embodiments, the optimization control assembly may determine the optimization data set in the optimization routine, such as the characteristic diagrams in the optimization data set, and/or the suggestions based on feature(s) of the field, such as a soil type and/or moisture of the field, and/or feature(s) of a crop, and/or feature(s) of a crop sequence. This may be separate from the optimization data from the combination. Alternatively, or in addition, the optimization control assembly may determine the optimization data set in the optimization routine, such as the characteristic diagrams in the optimization data set, and/or the suggestions based on a planned fleet size for the work process, and/or a planned work time window, and/or planned additional cultivation steps, and/or planned additional cultivation periods, thus being separate and apart from the optimization data regarding the combination.

In one or some embodiments, measured data from the sensor of previous work processes may be taken into account in the optimization routine. For example, the working height of the plow provides diverse relevant information on the state of the field. This is therefore another advantage of the sensor assembly, such as the modular sensor system. In this regard, in one or some embodiments, the optimization control assembly may determine the optimization data set in the optimization routine, such as the characteristic diagrams in the optimization data set, and/or the suggestions based on measured data from the sensor of past work processes.

In one or some embodiments, a performance sensor assembly (e.g., an optimization sensor assembly) configured for use in the disclosed method is disclosed. Reference is made to all statements regarding the disclosed method.

Referring to the figures, the disclosed solution may be applied to a wide range of agricultural production machines 1, such as self-propelled agricultural production machines 1. This may include prime movers, such as tractors, and harvesting machines, such as combines, forage harvesters, or the like.

In the embodiment that is depicted, the agricultural production machine 1 is a tractor. The agricultural production machine 1 may be equipped via at least one equipment interface 2 with at least one agricultural attachment 3. The equipment interface 2 in this case is very generally a mechanical coupling between the agricultural production machine 1 and the agricultural attachment 3. In the depicted embodiment, the equipment interface 2 is designed as a three point power lifter that has two lower links and one upper link for coupling to the agricultural attachment 3. The equipment interface 2 may be designed as a front or rear power lifter. In principle, the equipment interface 2 may also be a ball hitch. Other versions of the equipment interface 2 are systems with a simple drawbar coupling, with hitch hooks, with a ball head coupling, or the like.

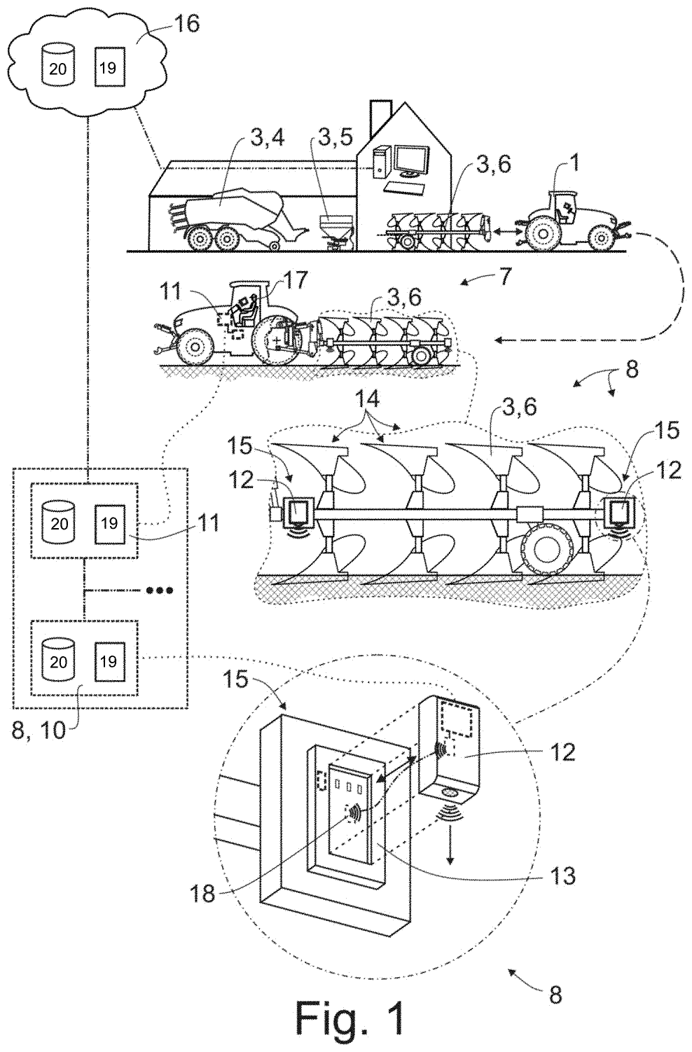

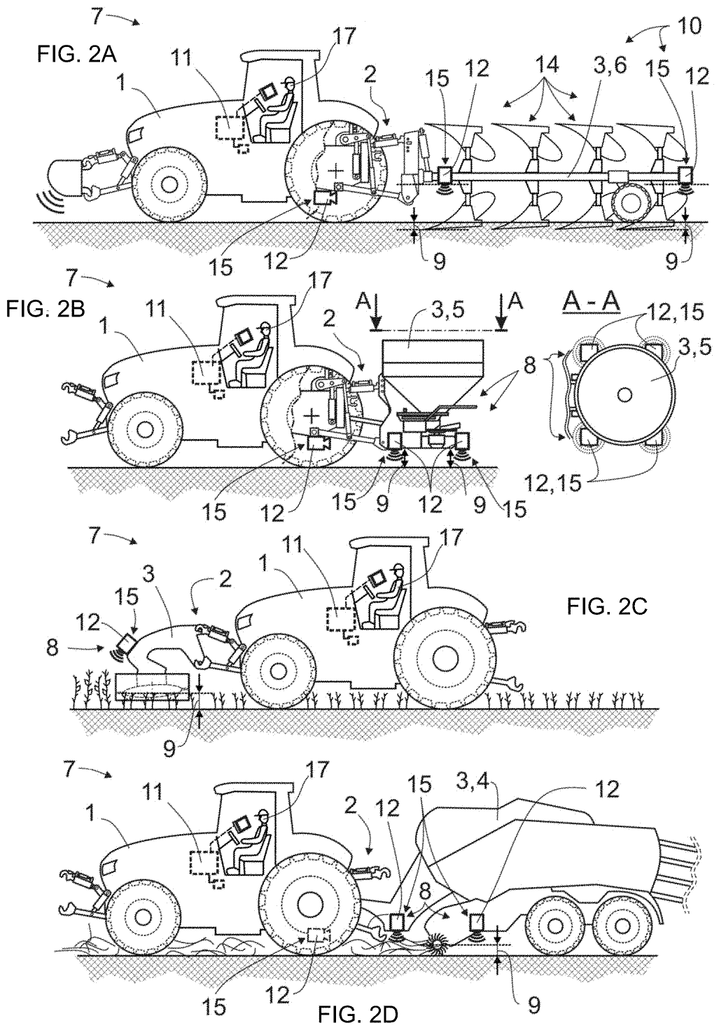

FIG. 1 shows several agricultural attachments 3 that may be used in the disclosed method, specifically a baler 4, an artificial fertilizer spreader 5, and a plow 6. These are shown in action in FIGS. 2A-D.

The embodiment depicted is a method for controlling (such as pre-optimizing) agricultural work processes for agricultural combinations 7. The agricultural combinations 7 have an agricultural production machine 1 and different agricultural attachments 3, wherein a sensor assembly 8 is provided for determining an absolute working height 9 of the agricultural attachments 3.

The sensor assembly 8 as such may be integrated independently at least partially in the agricultural production machine 1. In particular, the sensor control assembly 10 of the sensor assembly 8 may, for example, comprise a control assembly that is partly (or entirely) resident or part of the agricultural production machine 1. Likewise, the control assembly may, however, also comprise (or consist of) distributed computing units. The control assembly may, for example, have a control unit of the agricultural production machine 1 and a cloud control unit. Thus, in one embodiment, the control assembly is resident entirely within the agricultural production machine 1. Alternatively, the control assembly may be distributed with part on the agricultural production machine 1 and elsewhere (e.g., the cloud or on another device such as the agricultural attachment 3), or may be resident entirely outside of the agricultural production machine 1.

The agricultural combination 7 has a combination control assembly 11. The sensor assembly 8 has a sensor 12 for determining measured data relating to the absolute working height 9, a sensor holder 13, and a sensor control assembly 10.

Thus, the various control assemblies, such as any one, any combination, or all of the sensor control assembly 10, the combination control assembly 11, or optimization control assembly 16, or any other functionality described herein using computing logic, may comprise any type of computing functionality, such as at least one processor 19 (which may comprise a microprocessor, controller, PLA, or the like) and at least one memory 20. This is illustrated, for example, in FIG. 1, with the computing functionality equally applied to each of FIGS. 2A-D. The memory 20 may comprise any type of storage device (e.g., any type of memory). Though the processor 19 and memory 20 are depicted as separate elements, they may be part of a single machine, which includes a microprocessor (or other type of controller) and a memory. Alternatively, processor 19 may rely on memory 20 for all of its memory needs.

The processor 19 and memory 20 are merely one example of a controller assembly configuration. Other types of controller assembly configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Using the sensor 12, an absolute working height 9 is measured. The term “absolute” is not necessarily to be understood as a precise measurement, but generally as a measurement relative to the soil. It is contemplated for the measurement to be relative to a component whose height relative to the soil is known. In one or some embodiments, however, the absolute working height 9 is measured directly relative to the soil. It may also be a working depth if the agricultural attachment 3 enters into the soil. In principle, the working height 9 relates to a component of the agricultural attachment 3 that serves to work the field. This fieldwork may however also be sowing or the like. For example, the absolute working height 9 relates to the distance of a plowshare 14 to the soil, in this case generally the working depth, the distance of a discharge of a manure spreader or sprayer to the soil, or the like. In one or some embodiments, the focus is on the soil cultivation equipment, which is why the working height 9 may comprise a working depth.

In one or some embodiments, the combination control assembly 11 and the sensor control assembly 10 may at least partly overlap each other or may be identical.

In the state of the sensor being mounted at a mounting position 15 (e.g., resident in sensor holder), the sensor 12 records measured data relating to an absolute working height 9 of the particular agricultural attachment 3 and transmits at least a part (or all) of the measured data to the combination control assembly 11, wherein the combination control assembly 11 controls and/or regulates machine parameters of the particular agricultural combination 7 based on an optimization data set and the measured data during the working process.

The mounting position 15 may be arranged or positioned on the agricultural attachment 3 or the agricultural production machine 1. The mounting position 15 may be fixed or variable. In one or some embodiments, the mounting position 15 is adapted to the work process as will be explained in the context of the modular sensor system. Likewise, the sensor 12 may, however, also be fixedly connected (such as temporarily connected) to the agricultural production machine 1.

The measured data may be transmitted by the sensor 12 to the combination control assembly 11 in any manner whatsoever. In particular, the sensor 12 does not have to actively send the data; instead, the sensor may generate the measured data and another device may read out the measured data stored at or by the sensor. (such as temporarily fixed) the transmission is regular and/or continuous.

Moreover, a performance control assembly, one example of which is an optimization control assembly 16, is provided which, in a performance routine, such as an optimization routine, determines any one, any combination, or all of: the performance data set (e.g., the optimization data set) from competing performance goals (e.g., competing optimization goals); performance data apart from the agricultural combination 7 (e.g., optimization data apart from the agricultural combination 7); and data relating to the agricultural combination 7 (e.g., optimization data relating to the agricultural combination 7). In one or some embodiments, the performance routine (e.g., the optimization routine) may be performed or executed before performing the work process, with the results of executing the performance routine (such as any one, any combination, or all of the performance data set, the performance data apart from the agricultural combination 7, or the performance data relating to the agricultural combination 7 being made available to the combination control assembly 11 (e.g., being made available before or during performing the work process)).

In one or some embodiments, the optimization data set has suggestions for settings of machine parameters of the agricultural combination 7 optimized with respect to the optimization goals depending on other machine parameters of the agricultural combination 7, and/or measured data of the agricultural combination 7.

In one or some embodiments, optimized settings need not necessarily be understood as the completely optimum settings, but only those that were optimized. The quality of optimization depends on many factors, not least the target specifications of the optimizations as well.

The optimization control assembly 16 in this case may be arranged partly or completely apart from the agricultural combination 7.

Contemplated optimization goals are, for example, cost efficiency and/or speed of performing the work process. With respect to the suggestions, the suggestions may be displayed to the user 17 who may accept, reject, or modify them. In one or some embodiments, some or all of the suggestions may however also be implemented automatically.

In one or some embodiments, at least some of the agricultural attachments 3 are independent vehicles with at least one independent axle and independent wheels. In addition or alternatively, the agricultural attachment 3 may be designed without an axle or wheels and be borne by the tractor or another agricultural attachment 3. In this regard, reference is made to the equipment interfaces 2 previously mentioned.

In one or some embodiments, the sensor assembly 8 is configured to determine the absolute working height 9 of a plurality of different agricultural attachments 3 using the same sensor 12, and that the optimization data set has a suggestion for a working height 9 of the agricultural attachment 3 optimized with regard to the optimization goals, and/or suggestions for settings of other machine parameters of the agricultural combination 7 that are dependent on a set working height 9 and optimized with regard to the optimization goals. Accordingly, the determined working height 9 may be taken (such always be taken) into account during optimization, wherein it may be controlled or regulated directly or serves as a basis for controlling or regulation.

The working height 9 per se may have an influence on various optimization goals. With a plow 6 for example, the working height 9, in this case the working depth, has a major influence on the quality of the fieldwork and on the fuel consumption. The speed of the fieldwork and the possibility of distributing energy from the agricultural production machine 1 to other work assemblies also depend on the working height 9. The deeper, for example, a plow 6 plows, the slower the agricultural combination 7 must move physically due to the motor output.

Optimization data of the agricultural combination 7 may, for example, be machine parameters, dependencies of the machine parameters on each other, such as the dependence of fuel consumption on the working height 9, kinematics of the agricultural attachment 3, etc. The optimization data apart from the combination may comprise fuel consumption depending on the features of the soil of the field in general, the weather, and an influence of the weather on the fieldwork, etc.

In one or some embodiments, the optimization data set may, for example, have an equation system in the form of characteristic diagrams in which some optimization goals are still variable and may be chosen on site, whereas various factors are already fixedly taken into account. Alternatively or in addition, the optimization data set may form the basis for calculating characteristic diagrams by, in particular, the combination control assembly 11.

In one or some embodiments, the sensor 12 is reversibly mounted on the agricultural attachments 3, and the sensor 12 is used to determine the working height 9 of a plurality of agricultural attachments 3 and may be mounted on the agricultural attachment 3 to do this. In one or some embodiments, the sensor 12 is reversibly mounted at a mounting position 15 on different agricultural attachments 3 using the at least one sensor holder 13, the sensor holder 13 may be mounted separate from the sensor 12 on the different agricultural attachments 3, and the sensor 12 may be reversibly mounted in the sensor holder 13. Thus, in practice, the single sensor 12 may be installed in a first sensor holder 13 on one agricultural attachment 3 and thereafter installed in a second sensor holder 13 on another agricultural attachment 3. FIGS. 2A-D illustrate various possible mounting positions 15, each with a sensor 12 mounted therein. It is however contemplated not to include sensors 12 in all of the installed sensor holders 13, and rather to only include a sensor 12 (or sensors 12) in less than all of the sensor holders 13.

Moreover, in one or some embodiments, the sensor 12 is a contact-free distance sensor, such that the distance sensor functions on the basis of electromagnetic waves, or acoustic waves, or mechanical sensing. In one or some embodiments, the distance sensor is a radar sensor, or a lidar sensor, or an optical sensor, or an ultrasonic sensor, or the sensor 12 comprises a force sensor or position sensor, on a component touching the ground, such as a sensing bracket, a grinding skid or a support roller.

In one or some embodiments, the sensor control assembly 10 and/or the combination control assembly 11 determines the working height 9 of the particular agricultural attachment 3 from a mounting-position-specific calibration data set (e.g., a calibration data set that is tailored to a particular mounting position). Overall, all of the functions described with respect to the sensor control assembly 10 may also be performed by the combination control assembly 11, or both may be performed by a common control assembly.

In one or some embodiments, the sensor 12 is reversibly mounted using the sensor holder 13 at the mounting position 15 such that the mounting is nondestructively reversible. In one or some embodiments, the installation of the sensor holder 13 is at manufacture of the agricultural attachment. Alternatively, the installation of the sensor holder 13 is done after manufacture, such as on site on the field using simple tools, or entirely without tools.

The mounting-position-specific calibration data set, as will be explained, may in principle be saved in any desired memory, created new, or provided to the sensor control assembly 10 in a different way.

An advantageous use of the modular sensor system relates to the measurement of the working height 9 of an agricultural attachment 3 that does not have its own electronics. As will be seen below, the sensor assembly 8 may therefore be independent from the agricultural attachment 3. Alternatively, the sensor 12 does not communicate with the agricultural attachment 3. It may also equally be provided that the sensor 12 is integrated in electronics of the agricultural attachment 3 or communicates therewith. Also in the case of agricultural attachments 3 with electronics, it may however be provided that the sensor 12 does not communicate directly with the agricultural attachment 3. In one or some embodiments, the sensor assembly 8 may be used with agricultural attachments 3 with and without electronics. Alternatively, the determination of the working height 9, apart from the calibration itself, is completely independent of the agricultural attachment 3.

In one or some embodiments, the situation is such that the mounting-position-specific calibration data sets comprise any one, any combination, or all of: a reference height; an orientation of the sensor 12 in the mounted state at the particular mounting position 15; or a location of the mounting position 15 relative to the agricultural attachment 3.

In one or some embodiments, the reference height may originate from a calibration routine yet to be explained, and may relate to a height of the mounting position 15 of the sensor 12 in a reference state, such as with a known working height 9. The orientation of the sensor 12 may, for example, be a tilt of the sensor 12. This may take into account that the sensor 12 might not measure the shortest distance to the ground. The location of the mounting position 15 relative to the agricultural attachment 3 may be selected from a group of given mounting positions 15 or may be determined in another way. FIG. 1, for example, shows two mounting positions 15 on a plow 6. FIGS. 2A-D also show several possible mounting positions 15 on different agricultural attachments 3. As will be explained, it is also possible to measure several working heights 9 per agricultural attachment 3 and thereby record for example an angle of the agricultural attachment 3. To accomplish this, it may be necessary to locate the mounting position 15 of one or more sensors 12.

In one or some embodiments, the mounting-position-specific calibration data sets are saved in a memory of the sensor control assembly 10. In this case, this memory may comprise a local memory of the agricultural production machine 1. In principle, a cloud memory or the like is also contemplated. Calibration data sets relating to mounting positions 15 of at least two, such as at least three, different types of agricultural attachments 3 may be saved in the memory.

In this case, the agricultural attachments 3 may comprise types of agricultural attachments 3 for which the particular control assembly 10, 11 determines a working height 9. The different types of agricultural attachments 3 may comprise at least one type of soil cultivation device, such as at least two types of soil cultivation devices. The types of soil cultivation devices may comprise a plow 6, and/or a cultivator, and/or a harrow. The different types of agricultural attachments 3 may comprise artificial fertilizer spreader 5 and/or a seeder, such as a sowing coulter, and/or a mower, and/or a pickup, and/or an agricultural attachment 3 with a pickup, such as a baler 4 or a loader wagon.

As shown in the lower region of FIG. 1, the sensor holder 13 may be mounted separately from the sensor 12 on the different agricultural attachments 3. The sensor 12 is then reversibly mountable on the sensor holder 13. In one or some embodiments, the sensor holder 13 is a relatively inexpensive mass-produced component, while the sensor 12 itself is relatively expensive. The disclosed method allows the expensive sensor 12 to be reused (e.g., slotted at different times into different sensor holders 13).

For reasons of convenience, the sensor holder 13 may remain on (such as affixed on) the agricultural attachment 3. On the one hand, this has clear advantages in the context of the calibration routine yet be explained, but on the other hand it also enables the sensor holder 13 to be mounted in a stable and more permanent manner, while the mounting of the sensor 12 on the sensor holder 13 itself may be relatively simple. This also allows the same mounting position 15 to be reused when the sensor 12 is attached again. Accordingly, in one or some embodiments, the mounting-position-specific calibration data set may also be assigned to the sensor holder 13 at the corresponding mounting position 15. In order to depict this assignment, in one or some embodiments, the sensor holder 13 has an identification feature 18. The identification feature 18 may comprise information indicative of uniquely identifying the specific sensor holder 13 and/or the specific mounting position.

In one or some embodiments, the identification feature 18 may be transmitted from the sensor holder 13 to the sensor control assembly 10. However, in some embodiments, this sensor holder 13 does not have its own electronics. In particular, in one or some embodiments, the sensor 12, such as in the mounted state in the sensor holder 13, reads out the identification feature 18 and transmits part or all of the identification feature 18 to the sensor control assembly 10. In one or some embodiments, the sensor holder 13 has a near field communication (NFC) tag. The sensor 12 may then have an NFC reader, through which the sensor 12 reads out the identification feature 18 of the sensor holder 13 and transmits the identification feature 18 to the sensor control assembly 10. Alternatively, the user 17 may enter the identification feature 18 via an input device, such as a smartphone, or read the identification feature 18 out with the smartphone. The input device may then communicate with the sensor control assembly 10, or may be part of the sensor control assembly 10. In one or some embodiments, the identification feature 18 may comprise a QR code that the user 17 reads out, for example, in a dedicated app. Alternatively, the sensor 12 may read out the QR code. All these possibilities allow the sensor 12 to be quickly mounted, which leads directly to the usability of the sensor 12 for determining the working height 9. Instead of a smartphone, a tablet, a laptop, a smartwatch or the like may also be used.

Additionally or alternatively, the user 17 may select the mounting-position-specific calibration data set from an input unit, such as an input unit of the agricultural production machine 1 that communicates with the sensor control assembly 10. Alternatively, the sensor control assembly 10 may automatically select the mounting-position-specific calibration data set based on the identification feature 18 (e.g., the sensor control assembly 10 may receive the identification feature 18, either from the sensor, from the user, or elsewhere; the sensor control assembly 10 may access a look-up table correlating identification features with mounting-position-specific calibration data sets, and may select the particular mounting-position-specific calibration data set correlated to the identification feature 18 received).

In this case, the sensor control assembly 10 may perform a calibration routine in which the sensor control assembly 10 generates a mounting-position-specific calibration data set and may save mounting-position-specific calibration data set in the memory. This calibration routine is explained in greater detail below. In one or some embodiments, in the calibration routine, the sensor control assembly 10 saves a reference height and/or an orientation of the sensor 12 in the mounted state at the particular mounting position 15, and/or a location of the mounting position 15 relative to the agricultural attachment 3 in the mounting-position-specific calibration data set.

In this case, the calibration routine may be performed on level ground. In so doing, the sensor control assembly 10 may inform the user 17 that he/she should park the agricultural production machine 1 and/or the agricultural attachment 3 on level ground, and/or assume that this has been done. Moreover, the agricultural attachment 3 may assume a reference height. In the case of a plow 6, the reference height may, for example, be established at a working height 9 of zero when the plowshares 14 are placed on the ground. However, in a seeder, for example, it may also happen that the lowest adjustable height and a usual working height 9 are too far apart to calibrate the sensor 12 in this manner and still remain within the specification of the sensor 12 during use. Therefore, it may equally be provided that the user 17 may enter or otherwise determine the reference height.

In one or some embodiments, the sensor control assembly 10 uses the sensor 12 in the calibration routine to measure a distance of the sensor 12 from the ground and stores this as the reference height. What is particularly interesting about this is that the mounting position 15, which may be specified by the sensor control assembly 10, does not have to be precisely maintained by the user 17, especially in the height direction, since it is removed from the reference height when the working height 9 is determined. In other directions as well, great precision is usually not important due to the tolerances prevailing in agriculture.

If the agricultural attachment 3 has its own setting options for the working height 9, it may be provided that the settings present during the calibration routine are also saved in the mounting-position-specific calibration data record, and changes to these settings may lead to the user 17 being warned, or are taken into account using the optimization data set when determining the working height 9.

Moreover, in this case, the sensor control assembly 10 may direct a user 17 through the calibration routine using an output unit in a natural language dialog, the sensor control assembly 10 may specify a mounting position 15 to the user 17, or the user 17 may transmit the mounting position 15, such as by voice entry, to the sensor control assembly 10. In addition or alternatively, the sensor control assembly 10 may tell the user 17 of a setting of a working height 9 of the agricultural attachment 3, or the user 17 may transmit the setting of a working height 9, such as by voice entry, to the sensor control assembly 10, and/or the sensor control assembly 10 tells the user 17 to place the agricultural production machine 1 and/or the agricultural attachment 3 on flat ground.

The dialog may be performed using a voice output device and/or voice input device of the agricultural production machine 1 and/or a smartphone. However, it is equally possible to use a terminal of the agricultural production machine 1 and/or the smartphone without voice input and/or output.

In this case, the agricultural production machine 1 and/or the agricultural attachment 3 is on level ground during the calibration routine, the user 17 mounts the sensor holder 13 at a mounting position 15 on the agricultural attachment 3 and connects the sensor 12 to the sensor holder 13, and the sensor control assembly 10 performs a calibration routine in which the sensor control assembly 10 determines a reference height and generates a mounting-position-specific calibration data set and may save it in the memory.

The output unit may be the terminal or the smartphone, and/or may have the voice output device.

In one or some embodiments, the sensor 12 is mountable on the sensor holder 13 in a form fit and/or force fit, the sensor 12 may be mountable on the sensor holder 13 using a quick-locking device, and/or using one or more screws, and/or magnetically, and/or is clipable in the sensor holder 13. In one or some embodiments, the sensor 12 may be mounted on the sensor holder 13 using commercially available tools or without any tools at all.

In one or some embodiments, the sensor holder 13 has a battery and/or an electrical connection unit, such as a cable or an antenna, for connection to the control assembly, and/or for transmitting energy from an agricultural production machine 1 to the sensor 12, the electrical connection unit may have a bus connection, in particular an ISOBUS or CAN bus connection.

Using a sensor holder 13 with such a design, the sensor 12 may be supplied with energy. At the same time or alternatively, the sensor holder 13 may be used to transmit the data from the sensor 12 to the sensor control assembly 10. In one or some embodiments, the sensor control assembly 10 is part of the agricultural production machine 1, or the connection to the sensor control assembly 10 runs via the agricultural production machine 1. If the sensor holder 13 has a cable that may be connected to a bus of the agricultural production machine 1 if necessary, and if the sensor holder 13 remains on the agricultural attachment 3, the wiring only has to be done once. This is a logical extension of the “plug and play” concept of the sensor assembly 8. The battery may alternatively be chargable. In the same way, the sensor 12 may also have its own battery or be chargable. In particular, it is also contemplated for the sensor holder 13 to have no electronics at all, in which case the NFC tag does not count as electronics (such as not considered active electronics). Provided that the agricultural attachment 3 has its own power supply, which may be powered by the agricultural production machine 1, the sensor 12 may also be connected thereto, such as via the sensor holder 13 (e.g., the sensor holder 13 may have a connection, which includes one or more pins for communication and one or more pins for supplying power; the sensor 12, installed in the sensor holder 13, may connect to the connection, thereby connecting to the one or more pins for communication and to the one or more pins for receiving power).

As previously noted, various agricultural attachments 3 may have different relevant working heights 9. For example, a plow 6 with several plowshares 14 is shown in FIG. 2A. Each of these plowshares 14 has its own working height 9. If the plow 6 is for example strongly angled along its longitudinal axis, optimization of only one working height 9 would not yield optimal results.

In one or some embodiments, the sensor control assembly 10 additionally determines the working height 9 from an agricultural attachment-specific calibration data set, and the agricultural attachment-specific calibration data set comprises kinematics of the particular agricultural attachment 3, and/or the sensor control assembly additionally determines the working height 9 from a coupling data set, and the coupling data set comprises machine parameters of a equipment interface 2 between the agricultural production machine 1 and the particular agricultural attachment 3, which the coupling data set may comprise machine parameters of a three-point power lifter.

Using the agricultural attachment-specific calibration data set and coupling data set, the number of necessary sensors 12 to determine several working heights 9 may be reduced, for example, via an axis transformation using the kinematics of the agricultural attachment 3 or via known machine parameters of the equipment interface 2. The determination of a single working height 9 may also be verified or performed more precisely in this way, if necessary. In one or some embodiments, however, at least one working height 9 may be determined without taking into account the machine parameters of the equipment interface 2.

In principle, the agricultural attachment-specific calibration data set may be contained in the mounting-position-specific calibration data set, or vice versa. The coupling data set may be attachment-specific, but does not have to be. It may comprise, for example, lengths of hydraulic cylinders of the equipment interface 2. Generally speaking, machine parameters are to be understood as any and all of the settings, associated sensor measured values, and the like. In this case, the machine parameters may relate at least partially to machine parameters that have a direct influence on the working height 9 that is to be detected.

In one or some embodiments, the optimization data set has characteristic diagrams which depict the dependencies of the settings of machine parameters, such as the working height 9, of the agricultural combination 7 from other machine parameters of the agricultural combination 7 and/or measured data of the agricultural combination 7, and the combination control assembly 11 controls the agricultural combination 7 within an operating range (such as within a designated operating range) of the characteristic diagrams based on the characteristic diagrams, and may adapt or modify the characteristic diagrams when the working range of the characteristic diagrams is left (e.g., when the agricultural combination 7 operates outside of the working range).

In one or some embodiments, characteristic diagrams are equations or combinations of equations and/or inequations, or dependencies depicted in some other way between settings of machine parameters, measured data, influential factors, etc. In this case, at least one characteristic diagram may comprise the dependency of the working height 9 on machine parameters and/or field parameters. Accordingly, the working height 9 may, for example, be dependent on settings of the equipment interface 2. The working height 9 itself may influence or affect the fuel consumption, a quality of work, etc. In one or some embodiments, the characteristic diagrams are configured so that they are constant with respect to some influencing factors and flexible with respect to other influencing factors. The characteristic diagrams may comprise input parameters and output parameters, wherein the input parameters are for example measured data, and the output parameters are settings for machine parameters. Since the characteristic diagrams are precalculated, optimization of the output parameters may be achieved within the operating range with relatively little computing effort. If the basic assumptions of the characteristic diagrams change too much, the characteristic diagrams may be adapted.

In one or some embodiments, the optimization data set depends on the mounting position, the optimization data set may have at least one mounting-position-dependent characteristic diagram, such as the mounting-position-dependent characteristic diagram may depict the settings of machine parameters of the agricultural combination 7 depending on the working height 9 at the mounting position 15.

In this case, the situation is such that the optimization data set comprises suggestions of settings for motor regulation depending on the set working height 9, and/or a driving regulation, and/or a transmission regulation, and or a fan regulation, and/or for regulation of the equipment interface 2, such as a traction regulation, and/or a slip regulation, and/or a position regulations, and/or a mixing regulations of the traction and position regulation, and/or for contact pressure regulation, and/or a re-hardening regulation, and/or a seeding rate regulation of the agricultural attachment 3. It is also contemplated for the optimization data set to comprise suggestions for a body suspension and/or a tire pressure.

In one or some embodiments, agricultural combinations 7 may have various regulation systems. Thus, it may not be useful to create an overall regulation therefrom. Instead, in this case, suggestions for settings of these regulations may be derived from the optimization data set. Thus, in one or some embodiments, it is contemplated to take into account the equipment interface 2 of the agricultural production machine 1 whose regulation may have a direct influence on the working height 9.

Moreover, in one or some embodiments, the optimization control assembly 16 determines suggestions in the optimization routine for an optimized choice of one or more agricultural production machines 1, and/or agricultural attachments 3, and/or agricultural combinations 7 for the work process, and/or the optimization control assembly 16 determines suggestions in the optimization routine for an optimized selection of one or more sensors 12, and/or sensor types, and/or mounting positions 15, and/or a number of sensors in the sensor assembly 8.

The choice of the correct agricultural production machine 1 and/or the correct agricultural attachment 3 for a work process, or the optimization of several work processes and the distribution of the resources to the work processes may be beneficial. In conjunction with the modular sensor system, it is therefore possible to optimize some or all the work processes. Depending on the optimization goals, existing sensors 12 may be distributed to the agricultural production machines 1, and the agricultural attachments 3, and the mounting positions 15. If there are different types of sensors 12, this may also be taken into account. In so doing, the possibilities for on-site optimization using optimization data sets of the formed agricultural combinations 7 may be considered. The sensors 12 may, for example, be used where their measured data may achieve greater success. The characteristic diagrams in turn may be determined such that they take into account the existing sensors and the general plan. They may be correspondingly determined depending on some or all of the cited suggestions.

In this case, the optimization control assembly 16 may determine the optimization data set in the optimization routine depending on weightings of target specifications. In this case, the weighting of the target specifications may be incorporated in the characteristic diagrams, and more specifically, in one or some embodiments, changes to the weighting of at least some target specifications cannot force a change to the characteristic diagrams while the work process is being performed.

In one or some embodiments, the weightings of the target specifications may be specified by the user 17 or already known. Alternatively, the weightings may be automatically determined. In this case, the situation is such that a change to the target specifications, such as changes input by the user 17, typically (such as always) do not result in a change in the characteristic diagrams. Alternatively, the changes input by the user 17 result in a change in the characteristic diagrams. The situation is therefore such that the possible changes of some target specifications are already taken into account in the characteristic diagrams.

Moreover in this case, the user 17 may specify dialog-based weightings of the target specifications for controlling and/or regulating the agricultural combination 7 during the work process, the optimization data set may comprise an optimized working height 9 depending on the target specifications, and the combination control assembly 11 suggests and/or regulates an optimized working height 9 based on the optimization data set and the target specifications.

In one or some embodiments, the situation is such that the combination control assembly 11 suggests and regulates optimized different machine parameters based on the optimization data set, and the target specifications, and the optimized working height 9.

In this case, the target specifications may comprise minimum fuel consumption, and/or a maximum speed of performing the work process, and/or a minimization of the cost of the work process, and/or a maximization of the work quality. In one or some embodiments, the user 17 may visually adjust the weighting of the target specifications.

Moreover, in this case, the optimization control assembly 16 may determine suggestions for defaults of the agricultural production machine 1 and/or the agricultural attachment 3 in the optimization routine, and the optimization data set, such as the characteristic diagrams, may be dependent on the suggestions.

Defaults are understood to be such settings that cannot be automatically changed and/or cannot be changed while driving. In particular, the defaults may comprise manual settings that are normally only set once before starting the work process. This may be directed to settings of the agricultural attachment 3 or the agricultural production machine 1 to be adjusted manually. Examples are an axle ballast or tire pressure.

Moreover, in one or some embodiments, the optimization control assembly 16 determines the optimization data set in the optimization routine, such as the characteristic diagrams, and/or the suggestions based on features of the field, such as a soil type and/or moisture of the field, and/or a crop, and/or a crop sequence, as the optimization data apart from the combination. In addition or alternatively, the optimization control assembly 16 may determine the optimization data set in the optimization routine, such as the characteristic diagrams, and/or the suggestions based on a planned fleet size for the work process, and/or a planned work time window, and/or planned additional cultivation steps, and/or planned additional cultivation periods as the optimization data apart from the combination. Moreover, the optimization data apart from the combination may also contain a weather forecast.

The optimization data set therefore may form dependencies apart from the combination such as for example costs within an overall agricultural context.

It is also contemplated for the optimization control assembly 16 to determine the optimization data set in the optimization routine, such as the characteristic diagrams, and/or the suggestions based on measured data from the sensor 12 of past work processes.

In one or some embodiments, the measured data are saved for documentation. In one or some embodiments, the measured data from the sensor 12 may, however, be used for future plans of work processes. The optimization data set may accordingly take into account the working depth of a past plowing process, for example.

In addition according to another teaching which is independently relevant, an optimization control assembly 16 configured for use in the disclosed method is disclosed. Reference is made to all statements regarding the disclosed method

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural production machine
2 Equipment interface
3 Agricultural attachment
4 Baler
5 Artificial fertilizer spreader
6 Plow
7 Agricultural combination
8 Sensor assembly
9 Working height
10 Sensor control assembly
11 Combination control assembly
12 Sensor
13 Sensor holder
14 Plowshare
15 Mounting position
16 Optimization control assembly
17 User
18 Identification feature
19 Processor
20 Memory

1. A method for controlling an agricultural work processes, the method comprising:
in agricultural combinations, wherein the agricultural combinations include an agricultural production machine and different agricultural attachments, wherein a sensor assembly determines a working height of the different agricultural attachments, wherein the agricultural combination has a combination control assembly, wherein the sensor assembly has a sensor that determines measured data relating to the working height, a sensor holder and a sensor control assembly, wherein in a state of the sensor being mounted in the sensor holder at a mounting position, the sensor records the measured data relating to the working height of a particular attachment and transmits at least a part of the measured data to the combination control assembly, wherein the combination control assembly performs one or both of controlling or regulating machine parameters of a particular agricultural combination based on a performance data set and the measured data obtained during the agricultural work process,
determining, in a performance control assembly executing a performance routine, a performance data set from competing performance goals, performance data apart from the agricultural combination, and performance data relating to the agricultural combination before performing the agricultural work process, the performance data set including one or more suggestions for settings of machine parameters of the agricultural combination with respect to the performance goals depending on one or both of other machine parameters of the agricultural combination or the measured data of the agricultural combination; and
determining, using the sensor assembly, the working height of a plurality of different agricultural attachments using a same sensor;
wherein the performance data set has one or both of:
a suggestion for the working height of the agricultural attachment with regard to the performance goals; or
one or more suggestions for settings of other machine parameters of the agricultural combination that are dependent on a set working height and selected with regard to the performance goals.

2. The method of claim 1, wherein the same sensor is reversibly mounted on the different agricultural attachments, the same sensor is used to determine the working height of the different agricultural attachments and is always mounted on or in a respective agricultural attachment to perform this.

3. The method of claim 2, wherein the same sensor is reversibly mounted at a respective mounting position on the different agricultural attachments using at least one sensor holder, the at least one sensor holder being mounted separate from the sensor on respective ones of the different agricultural attachments.

4. The method of claim 2, wherein the sensor is a contact-free distance sensor that functions on a basis of electromagnetic waves, or acoustic waves, or mechanical sensing.

5. The method of claim 4, wherein the distance sensor is one of:
a radar sensor, or a lidar sensor, or an optical sensor, or an ultrasonic sensor; or
a force sensor or position sensor, on a component touching ground comprising a sensing bracket, a grinding skid or a support roller.

6. The method of claim 1, wherein the performance data set comprises an optimization data set that has characteristic diagrams which depict dependencies of setting machine parameters including the working height from one or both of other machine parameters of the agricultural combination or the measured data of the agricultural combination; and
wherein the combination control assembly controls, based on the characteristic diagrams, the agricultural combination so that the agricultural combination operates within an operating range of the characteristic diagrams.

7. The method of claim 6, wherein the combination control assembly adapts the characteristic diagrams when the agricultural combination operates outside of the operating range of the characteristic diagrams.

8. The method of claim 1, wherein the performance data set has at least one mounting-position-dependent characteristic diagram that is tailored to a respective mounting position and that depicts settings of machine parameters of the agricultural combination depending on the working height at the respective mounting position.

9. The method of claim 1, wherein the performance data set comprises suggestions of settings for one or more of:
motor regulation depending on a set working height;
driving regulation;
transmission regulation;
fan regulation;
regulation of an equipment interface that connects the agricultural production machine and the different agricultural attachments;
slip regulation;
position regulation;
mixing regulations of traction regulation and the position regulation;
contact pressure regulation;
re-hardening regulation; or
seeding rate regulation of the agricultural attachment.

10. The method of claim 1, wherein the performance control assembly determines suggestions in the performance routine for a performance choice of one or both of:
one or more of: agricultural production machines; agricultural attachments; or agricultural combinations for the agricultural work process; or
a performance selection of one or more of: sensors; sensor types; mounting positions; or a number of sensors in the sensor assembly.

11. The method of claim 1, wherein the performance control assembly determines the performance data set in the performance routine depending on weighting of target specifications.

12. The method of claim 11, wherein the performance data set has characteristic diagrams which depict dependencies of setting machine parameters including the working height from one or both of other machine parameters of the agricultural combination or the measured data of the agricultural combination;
wherein the weighting of the target specifications is incorporated in the characteristic diagrams; and
wherein changes to the weighting of at least some target specifications cannot force a change to the characteristic diagrams while the agricultural work process is being performed.

13. The method of claim 12, wherein a user specifies dialog-based weightings of the target specifications for one or both of controlling or regulating the agricultural combination during the agricultural work process;
wherein the performance data set comprises a performance working height depending on the target specifications; and
wherein the combination control assembly performs one or more of suggesting to the user or automatically regulating optimized different machine parameters based on the performance data set, and the target specifications, and an optimized working height.

14. The method of claim 12, wherein the performance control assembly determines suggestions for defaults of one or both of the agricultural production machine or the agricultural attachment in the performance routine; and
wherein the characteristic diagrams in the performance data set are dependent on the suggestions.

15. The method of claim 14, wherein the performance control assembly determines one or both of the characteristic diagrams or the suggestions:
based on one or more features of a field including one or more of a soil type, moisture of the field; a crop; a crop sequence, as optimization data apart from optimization of the agricultural combination; or
based on one or more of a planned fleet size for the agricultural work process; a planned work time window; planned additional cultivation steps; or planned additional cultivation periods as the optimization data apart from the optimization of the agricultural combination.

16. The method of claim 1, wherein the performance control assembly determines suggestions in the performance routine for a performance choice of one or both of:
one or more of: agricultural production machines; agricultural attachments; or agricultural combinations for the agricultural work process; or
a performance selection of one or more of: sensors; sensor types; mounting positions; or a number of sensors in the sensor assembly;
wherein the performance data set has characteristic diagrams which depict dependencies of setting machine parameters including the working height from one or both of other machine parameters of the agricultural combination or the measured data of the agricultural combination; and
wherein the performance control assembly determines one or both of the characteristic diagrams or the suggestions based on the measured data from the sensor of past work processes.

17. An agricultural production machine comprising:
an equipment interface configured to attach to a soil cultivating agricultural attachment to create an agricultural combination; and
one or more control assemblies configured to:
determine, executing a performance routine, a performance data set from competing performance goals, performance data apart from the agricultural combination, and performance data relating to the agricultural combination before performing a work process, the performance data set including one or more suggestions for settings of machine parameters of the agricultural combination with respect to the performance goals depending on one or both of other machine parameters of the agricultural combination or measured data of the agricultural combination, wherein the performance data set has one or both of: a suggestion for a working height of the agricultural attachment with regard to the performance goals; or one or more suggestions for settings of other machine parameters of the agricultural combination that are dependent on a set working height and selected with regard to the performance goals;
determine working height of a plurality of different agricultural attachments using a same sensor; and
use the suggestion for the working height of the agricultural attachment or the one or more suggestions for the settings of the other machine parameters to control one or both of the agricultural production machine or the soil cultivating agricultural attachment.

18. The agricultural production machine of claim 17, wherein the performance data set has at least one mounting-position-dependent characteristic diagram that is tailored to a respective mounting position and that depicts settings of machine parameters of the agricultural combination depending on the working height at the respective mounting position.

19. The agricultural production machine of claim 17, wherein the performance data set comprises suggestions of settings for one or more of:
motor regulation depending on a set working height;
driving regulation;
transmission regulation;
fan regulation;
regulation of the equipment interface;
slip regulation;
position regulation;
mixing regulations of traction regulation and the position regulation;
contact pressure regulation;
re-hardening regulation; or
seeding rate regulation of the agricultural attachment.

20. The agricultural production machine of claim 17, wherein one or more control assemblies is configured to determine suggestions in the performance routine for a performance choice of one or both of:
one or more of: agricultural production machines; agricultural attachments; or agricultural combinations for an agricultural work process; or
a performance selection of one or more of: sensors; sensor types; mounting positions; or a number of sensors in a sensor assembly.
